(19) United States
(12) Patent Application Publication
(10) Pub. No.: US 2017/0268644 A1
(43) Pub. Date: Sep. 21, 2017

(54) DUSTPROOF DEVICE FOR BALL SCREW

(71) Applicant: HIWIN TECHNOLOGIES CORP., Taichung City (TW)

(72) Inventors: Hong-Chun TENG, Taichung City (TW); Szu-Wei YU, Taichung City (TW); Wei-Lun LIU, Taichung City (TW)

(21) Appl. No.: 15/074,727

(22) Filed: Mar. 18, 2016

(51) Int. Cl. F16H 25/24; F16H 25/22

(52) U.S. Cl. CPC F16H 25/2418; F16H 25/2204

(57) ABSTRACT

A dustproof device is provided for use with a ball screw which includes a screw rod and a nut mounted around the screw rod. The dustproof device includes an annular body and an elastic valve plate. The annular body is provided at one end of the nut and penetrated by the screw rod and has an outer annular surface provided with a debris exit. The debris exit has one end in communication with a spiral passage formed between the screw rod and the nut. The elastic valve plate, which is provided at the opposite end of the debris exit of the annular body, can be pushed open by a fluid and thus opens the debris exit, allowing the debris generated by the ball screw to be discharged through the debris exit along with the fluid, thereby contributing to extending the service life of the ball screw.

### BACKGROUND OF THE INVENTION

1. Technical Field

The present invention relates to ball screws and more particularly to a dustproof device for a ball screw.

2. Description of Related Art

When a ball screw is in operation, the rolling contact between the screw rod, the nut, and the balls causes abrasion and hence the generation of debris, or dust. If the debris remaining in the gap between the screw rod and the nut is not removed, the precision of transmission and the smoothness of operation of the ball screw will be compromised, and the service life of the ball screw will be shortened as a result.

U.S. Pat. No. 5,231,888 discloses sucking internally generated debris with a suction device, and yet the suction device adds to the complexity of the entire structure and to the installation cost. Japanese Patent No. 4967809 uses a magnet to increase the closeness between the lip of a dustproof device and a screw rod, but debris tends to be attracted into and subsequently accumulate in the spiral groove of the screw rod. That is to say, the magnet, though contributing to an enhanced sealing effect, indirectly increases the operating resistance of the whole structure.

### BRIEF SUMMARY OF THE INVENTION

The primary objective of the present invention is to provide a dustproof device applicable to a ball screw and featuring structural simplicity, a good sealing effect, and effectiveness in removing the debris between the nut and the screw rod of a ball screw so as to extend the service life of the ball screw.

To achieve the above objective, the first dustproof device provided by the present invention includes an annular body and an elastic valve plate. The annular body is provided at one end of a nut and is penetrated by a screw rod. The annular body has an inner annular surface provided with a dustproof lip abutting against the periphery of the screw rod. The annular body further has an outer annular surface provided with at least one debris exit. One end of the debris exit is in communication with a spiral passage formed between the nut and the screw rod. The elastic valve plate is connected to the annular body and is located at the opposite end of the debris exit of the annular body.

When subjected to the pressure of a fluid, the elastic valve plate opens the debris exit, allowing debris to flow out with the fluid through the debris exit. Once the pressure of the fluid is removed, the elastic valve plate closes the debris exit thanks to the elastic restoring force of the elastic valve plate itself.

The second dustproof device provided by the present invention has a debris exit on the side facing away from the nut, and the debris exit is in communication with the spiral passage via at least one pore. When a fluid reaches the dustproof device via the spiral passage, the pressure of the fluid pushes the pore open so that debris can flow out of the debris exit through the pore along with the fluid. As soon as the pressure of the fluid is removed, the pore restores its original diameter or shape.

### BRIEF DESCRIPTION OF THE SEVERAL VIEWS OF THE DRAWINGS

FIG. 1 is a perspective view of the first embodiment of the present invention;

FIG. 2 is a perspective view of the first embodiment of the present invention applied to a ball screw;

FIG. 3 is a sectional view of the first embodiment of the present invention applied to a ball screw, showing in particular the debris exit in the closed state;

FIG. 4 is a sectional view of the first embodiment of the present invention applied to a ball screw, showing in particular the debris exit in the open state;

FIG. 5 is a perspective view of the second embodiment of the present invention;

FIG. 6 is a perspective view of the second embodiment of the present invention applied to a nut;

FIG. 7 is a sectional view of the second embodiment of the present invention applied to a nut, showing in particular the debris exit in the closed state;

FIG. 8 is a sectional view of the second embodiment of the present invention applied to a nut, showing in particular the debris exit in the open state;

FIG. 9 is a perspective view of the third embodiment of the present invention;

FIG. 10 is a front view of the third embodiment of the present invention;

FIG. 11 is a sectional view of the third embodiment of the present invention applied to a ball screw;

FIG. 12 is a perspective view of the fourth embodiment of the present invention;

FIG. 13 is a front view of the fourth embodiment of the present invention; and

FIG. 14 is a sectional view of the fourth embodiment of the present invention applied to a ball screw.

### DETAILED DESCRIPTION OF THE INVENTION

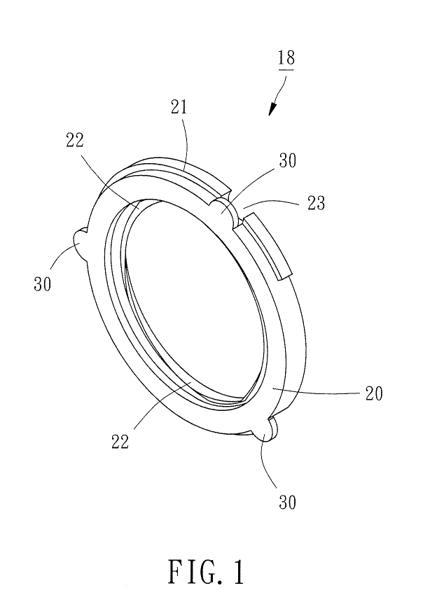

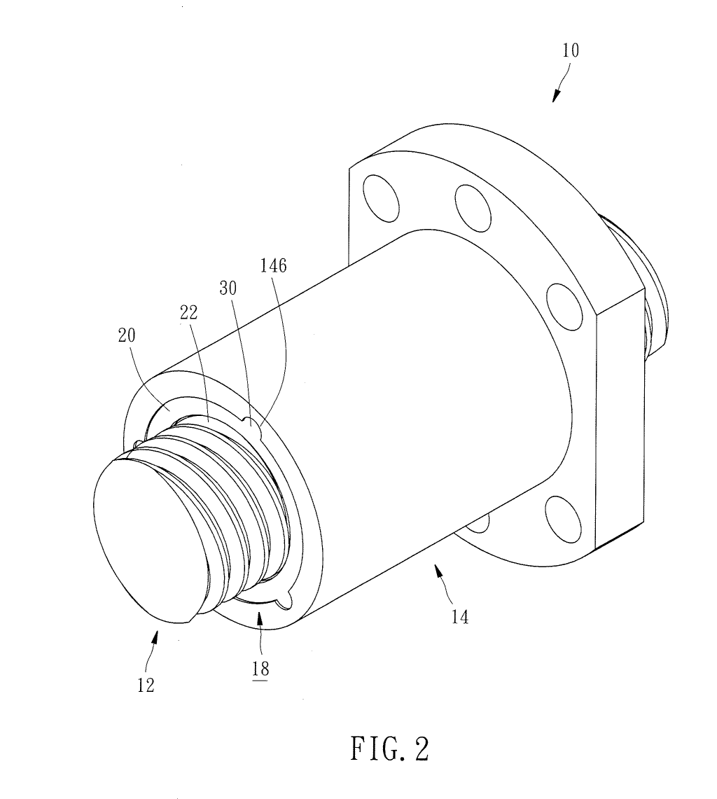

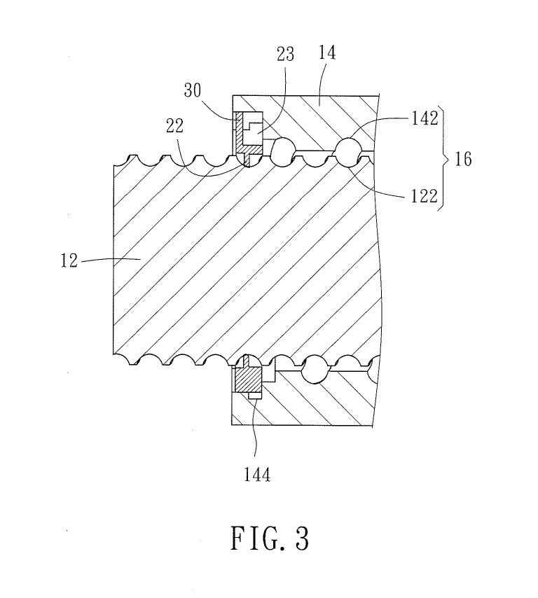

Referring to FIG. 2 and FIG. 3, the ball screw 10 in the drawings includes a screw rod 12, a nut 14 mounted around the screw rod 12, and a plurality of balls (not shown) provided between the screw rod 12 and the nut 14. The screw rod 12 is peripherally provided with an external spiral groove 122. The nut 14 has an inner periphery provided with an internal spiral groove 142. The external spiral groove 122 of the screw rod 12 and the internal spiral groove 142 of the nut 14 correspond to each other and jointly form a spiral passage 16 in and along which the balls can circulate. Referring to FIG. 1, the dustproof device 18 of the present invention includes an annular body 20 and three elastic valve plates 30.

The annular body 20 has two corresponding positioning flanges 21 on its outer annular surface and two corresponding dustproof lips 22 on its inner annular surface. To assemble, the screw rod 12 is inserted through the annular body 20 until the positioning flanges 21 are engaged in the positioning groove 144 in the inner periphery of the nut 14. After assembly, the dustproof lips 22 of the annular body 20 abut against the periphery of the screw rod 12 to produce a sealing effect, preventing foreign matters from entering the gap between the screw rod 12 and the nut 14. In addition, three debris exits 23 are arranged at an equal spacing along the outer annular surface of the annular body 20. Each debris exit 23 has an end which, after assembly, faces the nut 14 and is in communication with the spiral passage 16.

Each elastic valve plate 30 is provided at one debris exit 23 of the annular body 20, or more particularly at the end of the debris exit 23 that faces away from the nut 14. In this embodiment, the inner periphery of the nut 14 has three valve plate grooves 146 adjacent to the positioning groove 144. After assembly, the elastic valve plates 30, each having an end connected to the outer annular surface of the annular body 20, are located in the valve plate grooves 146 of the nut 14 respectively and seal the debris exits 23 respectively.

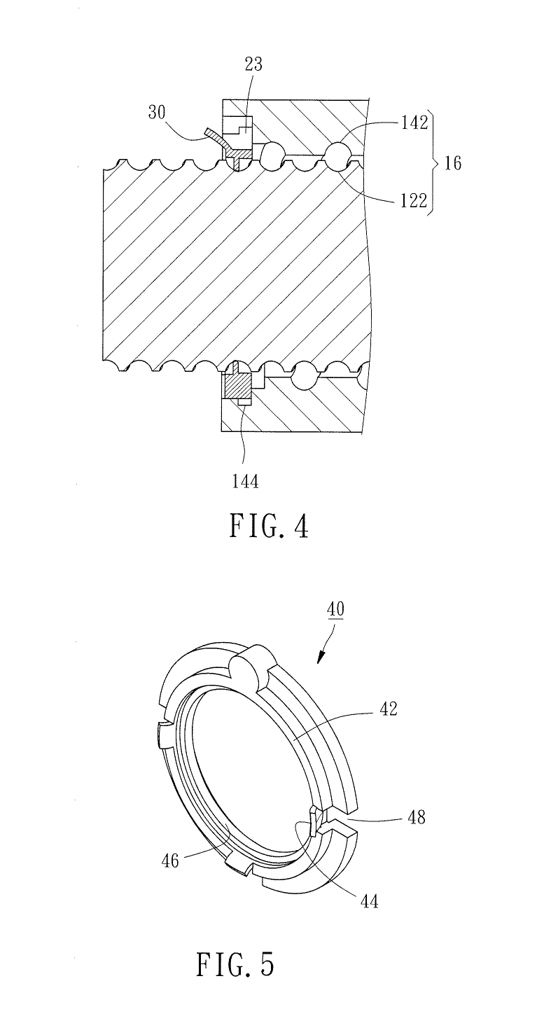

According to the above, a fluid (e.g., grease) injected into the nut 14 can carry debris along the spiral passage 16 to the debris exits 23, where the fluid applies an outward pushing force to the elastic valve plates 30. The pressure of the fluid pushes open the elastic valve plates 30 and hence the debris exits 23, as shown in FIG. 4, such that the debris is discharged together with the fluid through the debris exits 23. Once injection of the fluid is stopped, the pushing force applied by the fluid to the elastic valve plates 30 is removed, and the elastic valve plates 30 are driven by their inherent elastic restoring force to close the debris exits 23 respectively, as shown in FIG. 3.

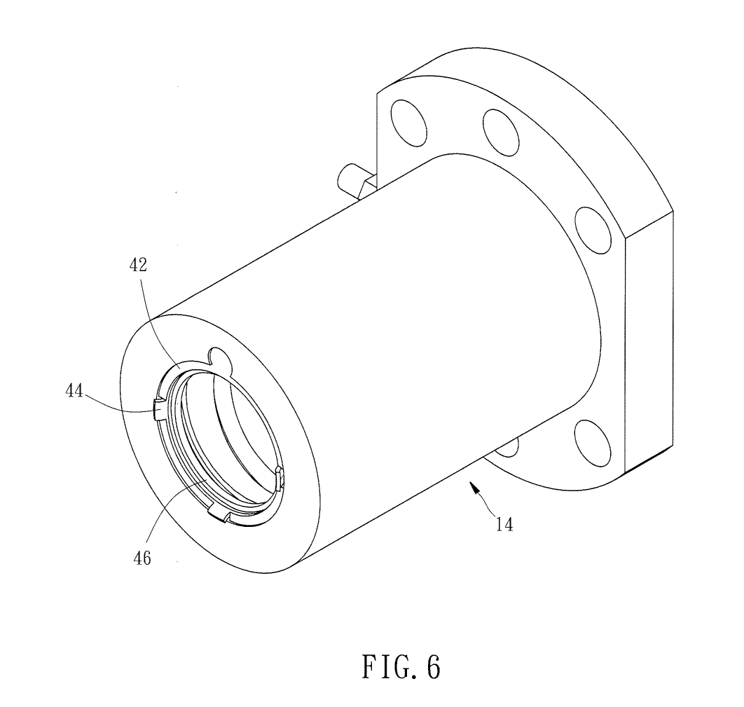

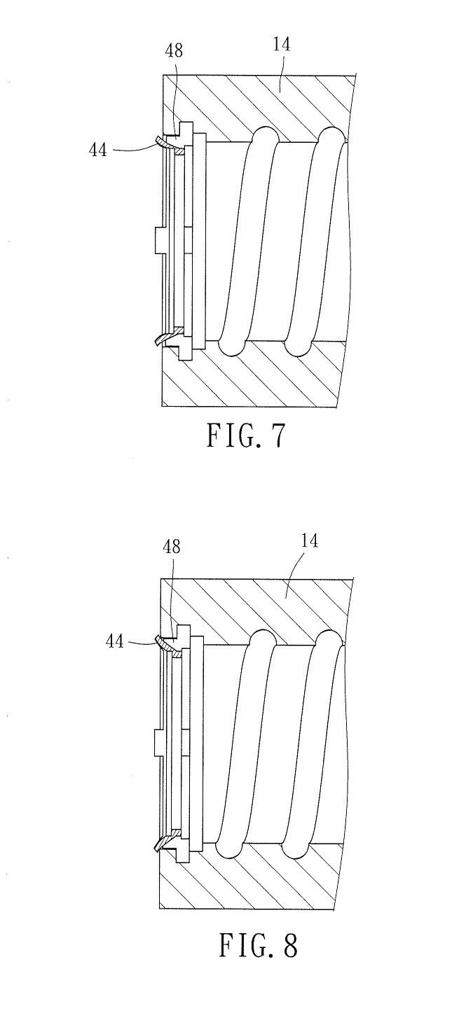

Referring to FIG. 5 for the dustproof device 40 according to the second embodiment of the present invention, each elastic valve plate 44 has one end connected to the inner annular surface of the annular body 42 and the opposite end extending away from the dustproof lip 46 and abutting against an end surface of the nut 14, as shown in FIG. 6. Thus, referring to FIG. 7 and FIG. 8, the elastic valve plates 44 open the debris exits 48 respectively when subjected to the pressure of a fluid, allowing debris to flow out of the debris exits 48 along with the fluid. When the pressure of the fluid is removed, the elastic valve plates 44 close the debris exits 48 respectively as a result of the elastic restoring force of the elastic valve plates 44.

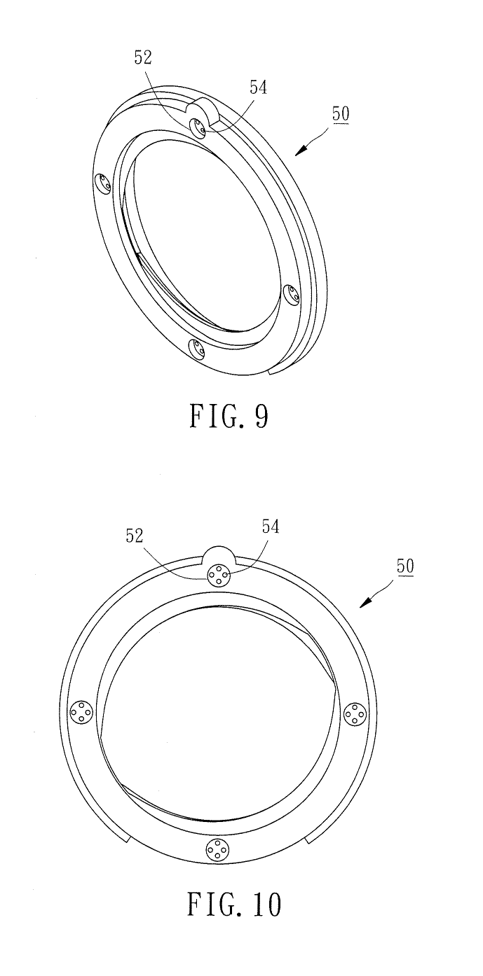

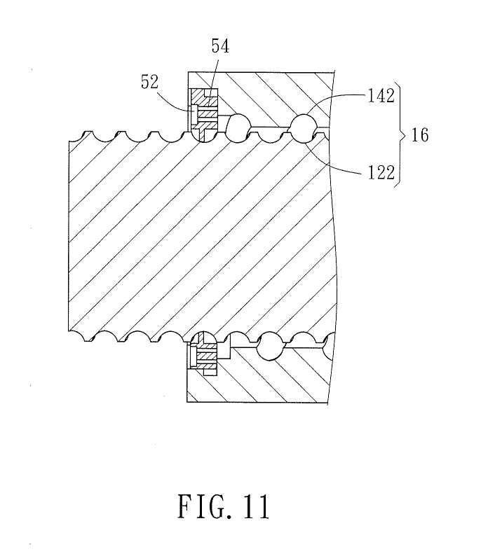

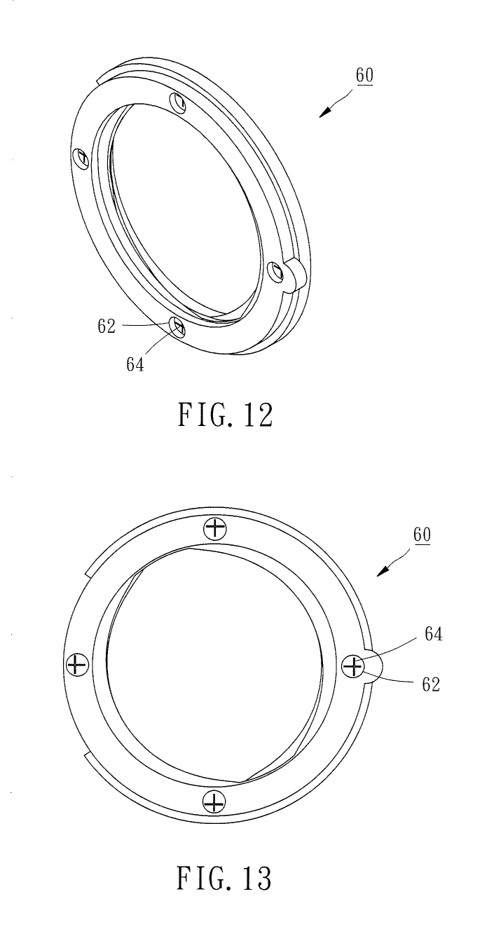

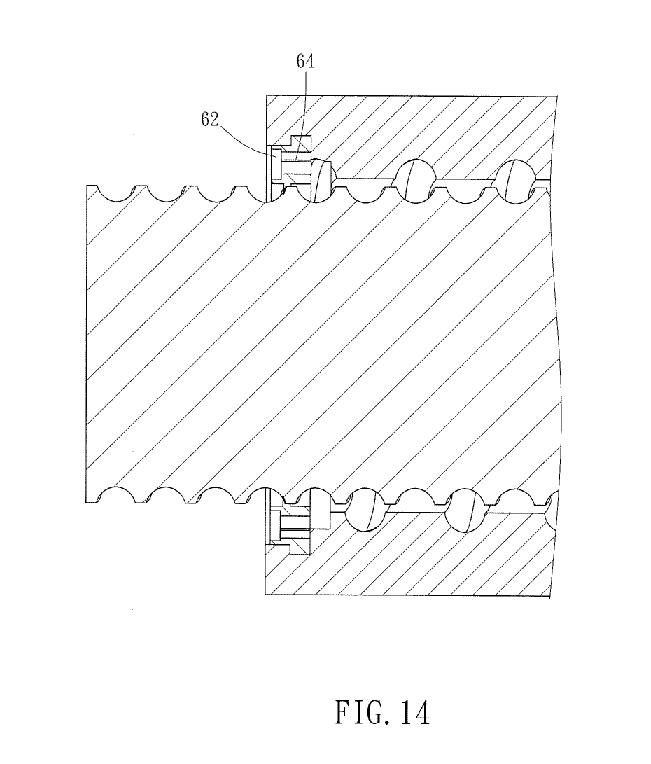

It is worth mentioning that the elastic valve plates are not essential to the dustproof device. Referring to FIG. 9 and FIG. 10 for the third embodiment of the present invention, the dustproof device 50 is made of an elastic material such as rubber and has a side facing away from the nut 14 and provided with four debris exits 52. The debris exits 52 are so arranged that the angular distance between each two adjacent debris exits is the same. Each debris exit 52 is in communication with the spiral passage 16 through four circular pores 54. Referring to FIG. 11, when a fluid flowing along the spiral passage 16 reaches the dustproof device 50, the pressure of the fluid can push open all the circular pores 54, allowing debris to flow out of the debris exits 52 with the fluid through the circular pores 54, whose diameters are now increased. Once the fluid pressure is removed, the walls of the circular pores 54 contract due to the elasticity of the material of the dustproof device 50 and thereby restore the circular pores 54 to their original diameters. In other embodiments where the same principle is applied, each debris exit of the dustproof device may have an equivalent of the plural circular holes instead. For example, referring to FIG. 12 to FIG. 14, each debris exit 62 of the dustproof device 60 includes one and only one cross-shaped pore 64. The cross-shaped pores 64 can be pushed open by the pressure of a fluid to enable discharge of debris through the debris exits 62. When the pressure of the fluid is removed, the cross-shaped pores 64 resume their original shapes.

According to the above, the dustproof device of the present invention not only provides a good sealing effect, but also features a simpler structure and can discharge the debris in the gap between the screw rod and the nut of a ball screw more effectively than its prior art counterparts to extend the service life of the ball screw.

What is claimed is:

1. A dustproof device for a ball screw, wherein the ball screw comprises a screw rod and a nut mounted around the screw rod, the screw rod has a periphery provided with an external spiral groove, the nut has an inner periphery provided with an internal spiral groove, and the external spiral groove of the screw rod and the internal spiral groove of the nut correspond to each other and jointly form a spiral passage, the dustproof device comprising:
an annular body provided at an end of the nut and penetrated by the screw rod, the annular body having an inner annular surface provided with a dustproof lip, the dustproof lip abutting against the periphery of the screw rod, the annular body further having an outer annular surface provided with at least one debris exit, the debris exit having an end in communication with the spiral passage; and
at least one elastic valve plate connected to the annular body and located at an opposite end of the debris exit of the annular body.

2. The dustproof device of claim 1, wherein the elastic valve plate has an end connected to the inner annular surface of the annular body and an opposite end extending away from the dustproof lip and abutting against the nut.

3. The dustproof device of claim 1, wherein the inner periphery of the nut has a valve plate groove, the elastic valve plate is in the valve plate groove of the nut, and the elastic valve plate has an end connected to the outer annular surface of the annular body.

4. A dustproof device for a ball screw, wherein the ball screw comprises a screw rod and a nut mounted around the screw rod, the screw rod has a periphery provided with an external spiral groove, the nut has an inner periphery provided with an internal spiral groove, and the external spiral groove of the screw rod and the internal spiral groove of the nut correspond to each other and jointly form a spiral passage, the dustproof device being provided at an end of the nut and penetrated by the screw rod, the dustproof device having an inner annular surface provided with a dustproof lip, the dustproof lip abutting against the periphery of the screw rod, the dustproof device having a side which faces away from the nut and is provided with a debris exit, the debris exit being in communication with the spiral passage via at least one pore.

5. The dustproof device of claim 4, wherein the dustproof device is made of an elastic material.

6. The dustproof device of claim 4, wherein the pore has a circular cross-section.

7. The dustproof device of claim 4, wherein the pore has a cross-shaped cross-section.
